(19) United States
(12) Patent Application Publication
(10) Pub. No.: US 2026/0357100 A1
(43) Pub. Date: Nov. 12, 2026

(54) COATING COMPOSITION FOR USE IN HIGH EFFICIENCY APPLICATORS

(71) Applicant: PPG Industries Ohio, Inc., Cleveland, OH (US)

(72) Inventors: Ronald James Kralic, JR., Beaver Falls, PA (US); Steven Edward Bowles, Pittsburgh, PA (US); Lindsay Elise Matolyak, Pittsburgh, PA (US); Brianne Colleen Hodanich, Allison Park, PA (US); David Michael Aiken, Freedom, PA (US); Douglas Ryan Vogus, Pittsburgh, PA (US); Randy Edward Daughenbaugh, Monroeville, PA (US)

(73) Assignee: PPG Industries Ohio, Inc., Cleveland, OH (US)

(21) Appl. No.: 19/123,981

(22) PCT Filed: Oct. 20, 2023
(86) PCT No.: PCT/US2023/077364

§ 371 Date: Apr. 24, 2025

Related U.S. Application Data
(60) Provisional application No. 63/380,970, filed on Oct. 26, 2022.

(51) Int. Cl. C09D 133/26; C09D 5/29; C09D 7/65

(52) U.S. Cl. CPC C09D 133/26; C09D 5/29; C09D 7/65

(57) ABSTRACT

A coating composition that includes 6 to 15 wt. % total solids, based on the weight of the coating composition; 15 to 70 wt. % based on the total solids, of core-shell resin particles; and 50 to 550 g/L, such as 100 to 500 g/L, or 150 to 450 g/L volatile organic compound (VOC) content. The coating composition can have a viscosity at 1000 s⁻¹ of from 30 to 110 mPa·s and a viscosity at 0.1 s⁻¹ of greater than 1000 mPa·s measured using an Anton-Paar MCR301 rheometer equipped with a concentric cylinder fixture (CC27 with gap size of 1.13 mm) at 25 °C and a pressure of 101.3 kPa (1 atm). The total solids and VOC can be determined according to ASTM D2369 (2020) and ASTM 3960 (2005) respectively. The coating composition is capable of being applied using a high transfer efficiency precision applicator.

### CROSS-REFERENCE TO RELATED APPLICATION

This application claims the benefit of priority of U.S. Provisional Application 63/380,970 filed Oct. 26, 2022, under 35 U.S.C. 119, titled “Coating Composition For Use In High Efficiency Applicators”, which is incorporated herein by reference.

### FIELD

This disclosure generally relates to coating compositions capable of being applied using high precision, high efficiency applicators.

### BACKGROUND

Coating compositions can be applied to a wide variety of substrates to provide color and other visual effects as well as various designs and patterns. For example, coatings can be applied to automotive substrates to provide two or more different colors on different portions of the substrate. To form different designs and patterns, masking materials are conventionally placed over different portions of the substrate and multiple applications of different coating compositions are applied over the substrate.

### SUMMARY

The present disclosure is directed to coating compositions that include (a) 6 to 15 wt. %, such as 6 to 14 wt. % or 7 to 13 wt. % total solids, based on the weight of the coating composition; (b) 15 to 70 wt. %, such as 20 to 65 wt. % or 25 to 60 wt. %, based on the total solids, of core-shell resin particles; and (c) 50 to 550 g/L, such as 100 to 500 g/L, or 150 to 450 g/L volatile organic compound (VOC) content. The coating composition can have a viscosity at 1000 s⁻¹ of from 30 to 110 mPa·s, such as 40 to 100 mPa·s, or 45 to 90 mPa·s and a viscosity at 0.1 s⁻¹ of greater than 1000 mPa·s, such as greater than 2500 mPa·s or greater than 4000 mPa·s measured using an Anton-Paar MCR301 rheometer equipped with a concentric cylinder fixture (CC27 with gap size of 1.13 mm) at 25 °C and a pressure of 101.3 kPa (1 atm). The total solids ASTM D2369 (2020) and VOC, ASTM D3960-05 (2005), can be determined using the referenced ASTM methods. The coating composition can be capable of being applied using a high transfer efficiency precision applicator.

### DETAILED DESCRIPTION

Unless otherwise indicated, conditions of temperature and pressure are ambient temperature (22 °C), a relative humidity of about 45%, and standard pressure of 101.3 kPa (1 atm).

Unless otherwise indicated, any term containing parentheses refers, alternatively, to the whole term as if parentheses were present and the term without them, and combinations of each alternative. Thus, as used herein the term, “(meth)acrylate” and like terms is intended to include acrylates, methacrylates and their mixtures.

It is to be understood that this disclosure may assume various alternative variations and step sequences, except where expressly specified to the contrary. Accordingly, unless indicated to the contrary, the numerical parameters set forth in the following specification and attached claims are approximations that can vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

All ranges are inclusive and combinable. For example, the term “a range of from 0.06 to 0.25 wt. %” would include each of from 0.06 to 0.25 wt. %, from 0.06 to 0.08 wt. %, and from 0.08 to 0.25 wt. %. Further, when ranges are given, any endpoints of those ranges and/or numbers recited within those ranges can be combined within the scope of the present disclosure.

As used herein, unless otherwise expressly specified, all numbers such as those expressing values, ranges, amounts or percentages can be read as if prefaced by the word “about”, even if the term does not expressly appear. Unless otherwise stated, plural encompasses singular and vice versa. As used herein, the term “including” and like terms means “including but not limited to”. Similarly, as used herein, the terms “on”, “applied on/over”, “formed on/over”, “deposited on/over”, “overlay” and “provided on/over” mean formed, overlay, deposited, or provided on but not necessarily in contact with the surface. For example, a coating layer “formed over” a substrate does not preclude the presence of one or more other coating layers of the same or different composition located between the formed coating layer and the substrate.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

As used herein, the term “adhesion promoter” refers to any material that, when included in the composition, enhances the adhesion of the coating composition to a substrate.

As used herein, the term “alkoxy-functional silicone” and like terms refers to silicones that include only alkoxy functional groups, —OR, wherein R can be an alkyl group or an aryl group.

As used herein, the terms “a” and “an” shall be construed to include “at least one” and “one or more”.

As used herein, the term “applicator” refers to any device capable of applying a coating composition to a substrate and can include without limitation a roller, a brush, a spray tip in fluid communication with a nozzle and a high efficiency applicator.

As used herein, the term “ASTM” refers to publications of ASTM International, West Conshohocken, PA.

As used herein, the term “basecoat” refers to a coating layer that is applied onto a primer, another basecoat layer; and/or directly onto a substrate, optionally including components (such as colorants) that impact the color and/or provide other visual impact.

As used herein the term “binder” refers to a compound or mixture of compounds used to bind the input materials, including pigments, fillers ctc., if present, in the coating composition and provide adhesion of the coating film to the underlying surface as a continuous film.

As used herein the term “clearcoat” refers to a coating layer that is at least substantially transparent or fully transparent and may not include a colorant. The term “substantially transparent” refers to a coating, wherein a surface beyond the coating layer is at least partially visible to the naked eye when viewed through the coating. The term “fully transparent” refers to a coating, wherein a surface beyond the coating layer is completely visible to the naked eye when viewed through the coating. The clearcoat can be substantially free of a pigment. Substantially free of a pigment can refer to a “tinted clearcoat”, which can be a coating composition that includes less than 3 weight % of pigment, based on the total solids, such as less than 2 weight %, less than 1 weight %, or 0 weight %.

As used herein, the term “coating” refers to the finished product resulting from applying one or more coating compositions to a substrate and forming the coating, as a nonlimiting example by curing. A primer layer, basecoat or color coat layer and clearcoat layer can comprise part of a coating. As used herein, the term “coating layer” is used to refer to the result of applying one or more coating compositions on a substrate in one or more applications of such one or more coating compositions. As a nonlimiting example, a single coating layer, referred to as a “color coat” or “topcoat” can be used to provide the function of both a basecoat and a clearcoat and can comprise the result of two or more applications of a color coat coating composition.

As used herein, the term “colorant” refers to any substance that imparts color and/or other opacity and/or other visual effect to a coating composition and can include, without limitation, dyes and pigments.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

As used herein, the term “continuous jet” refers to a continuous coating stream from a precision applicator applied to a substrate to provide a knife edge line where the applied coating ends.

As used herein, the term “core-shell resin particle” refers to a particle that includes a core, or interior domain, that is at least partially encapsulated by a shell, or surface domain. The core-shell particles can have various shapes (or morphologies) and sizes. As nonlimiting examples, the core-shell particles can have spherical, cubic, platy, polyhedral, or acicular (elongated or fibrous) morphologies.

As used herein, the term “crosslink” refers to a bond or a short sequence of bonds that links one polymer chain to another. “Highly crosslinked” refers to a situation where the number of crosslinks renders the polymer swellable, to some extent, but insoluble in a solvent or water at 0.05 wt. % at 25 °.

As used herein, the term “crosslinking agent” refers to a molecule or polymer containing functional groups that are reactive with the crosslinking-functional group of the polymers and/or resins in the coating composition.

As used herein, the term “crosslinking-functional group” refers to functional groups that are positioned in the backbone of a polymer, often, in a group pendant from the backbone of the polymer, terminally positioned on the backbone of the polymer, or combinations thereof, wherein such functional groups are capable of reacting with other crosslinking-functional groups or separate crosslinking agents during curing to produce a crosslinked coating.

As used herein, the terms “curable”, “cure”, and the like, as used in connection with a coating composition, refer to at least a portion of the components that make up the coating composition are polymerizable and/or crosslinkable when, as a nonlimiting example, exposed to higher temperatures (greater than 25 °C) or ultraviolet radiation.

As used herein the term “drop” refers to a column of liquid, bounded completely by free surfaces.

As used herein, the term “droplets” refers to drops of a coating composition from a precision applicator that are applied far enough apart to reduce the material volume applied, yet close enough to flow together and provide conformal coating coverage.

As used herein, “drop on demand” refers to a precision applicator that controls the volume of a single drop and only dispenses such a drop when indicated to do so.

As used herein the terms “dry” or “drying” refers to the removal of volatile compounds from a film, coating layer or an applied coating.

As used herein the term “dye” refers to a colored substance, in many cases an organic compound, that can chemically bond to a substrate or another component in a coating composition.

As used herein, the term “film-forming” materials refers to film-forming constituents of a coating composition and can include polymers, resins, crosslinking materials or any combination thereof that are film-forming constituents of the coating composition. Film-forming materials can be dried or cured.

As used herein, the term “flow rate” refers to the volume of a coating composition leaving an applicator per unit time, as a nonlimiting example cm3/minute.

As used herein, the term “fully transparent” refers to a coating, where a surface beyond the coating layer is completely visible to the naked eye when viewed through the coating.

As used herein, the term “gel” refers to a solution where storage modulu, G′, is greater than loss modulus, G″, i.e., tan (δ) (tan (δ)=G″/G′) becomes less than 1, where G′ and G″ values are measured at ω=1 rad/s and γ=1% at each concentration.

As used herein, the terms “gel transition” and “wt. % NV (non-volatiles)” refers to the concentration of resin or total solids where a solution becomes a gel, i.e., the concentration or wt. % NV when G′ became greater than G″, or, in other words, when the loss modulus, tan (δ) (tan (δ)=G″/G′) becomes less than 1.

As used herein, the term “high efficiency applicator” refers to precision application devices that can enable a coating composition to be applied over at least a portion of a substrate without overspray, as a nonlimiting example, greater than 85% Transfer Efficiency.

Unless otherwise indicated, as used herein, the term “insoluble” refers to a substance (solid) that will not dissolve in a solvent or water (as indicated) even after mixing at 0.05 wt. % at 25 °.

Unless otherwise indicated, as used herein, the term “molecular weight” refers to a weight average molecular weight as determined by gel permeation chromatography (GPC) using appropriate polystyrene standards. If a number average molecular weight is specified, the weight is determined in the same GPC manner, while calculating a number average from the thus obtained polymer molecular weight distribution data.

As used herein the terms “multi component”, “multi-K” and “multi-pack” refers to a coating composition that includes a first component that contains crosslinkable resins, a second component that contains crosslinking agents and additional components that may or may not contain crosslinkable resins or crosslinking agents, where the components are maintained separately until just prior to use. The crosslinkable resins and crosslinking agents are capable of reacting when combined to form a thermoset composition. When the multi component coating composition does not include additional components, it is a two-component coating composition.

As used herein, the term “nozzle” refers to a component of an applicator having an opening through which a coating composition flows, is ejected or jetted and, unless otherwise indicated, the term “nozzle” is used interchangeably with any of a valve jet, or piezo-electric, thermal, acoustic, or ultrasonic actuated valve jet or nozzle.

As used herein, “overspray” refers to a portion of a coating composition that does not land within a target area.

As used herein the terms “one component”, “1-K” and “1-pack” refer to a coating composition where all of the coating components are maintained in the same package after manufacture, during shipping and storage. As a nonlimiting example, a coating composition is considered a 1-K coating composition even if solvent(s) are added to the 1-K composition to lower the viscosity or solids thereof.

As used herein, the term “organic solvent” refers to carbon-based substances capable of dissolving or dispersing other substances.

As used herein, the term “overlap” refers to the amount of a coating composition in a path width that is applied over the coating composition of a previous path width.

Unless otherwise indicated, the term “particle size” refers to the Z average particle size of particles in an aqueous dispersion determined using a Zetasizer dynamic light scattering instrument, available from Malvern Panalytical Ltd., using a high performance two angle particle size analyzer.

As used herein, the term “path width” refers to the distance perpendicular to the direction of movement of an applicator where a coating composition is applied to a substrate.

As used herein, the term “pigment” refers to an organic or inorganic material or a combination thereof, that can be a colored material, that is insoluble in a solvent, and can also be functional, a nonlimiting example being anticorrosion pigments or effect pigments, nonlimiting examples including mica and aluminum.

As used herein the prefix “poly” refers to two or more. As a nonlimiting example, a polyisocyanate refers to a compound that includes two or more isocyanate groups and a polyol refers to a compound that includes two or more hydroxyl groups.

As used herein, the term “polyisocyanate” refers to blocked (or capped) polyisocyanates as well as unblocked polyisocyanates.

As used herein, the term “polymer” includes homopolymers (formed from one monomer) and copolymers that are formed from two or more different monomer reactants or that comprise two or more distinct repeat units. Further, the term “polymer” includes prepolymers, and oligomers.

As used herein, the term “primer coat” refers to an undercoating layer that can be applied onto a substrate in order to prepare the surface for application of a protective or decorative coating composition.

As used herein the term “rheological modifier” refers to materials that alter the rheology or flow properties of a fluid composition to which it is added and can include, but are not limited to natural gums, synthetic resins, organoclays, hydrogenated castor oils, fumed silicas, polyamides, associative thickeners, overbased sulfonates (as a nonlimiting example, colloidal calcium sulfonate dispersed in an oil, with excess sulfonate acting as the surfactant), inorganic crystals, non-aqueous microgels and polyurea compounds that are not soluble in organic solvents.

As used herein the term “sag” refers to the downward movement of a coating composition that can appear after application of the coating composition to a substrate and before the coating composition sets, cures and/or dries, nonlimiting examples include a dropping line, sagging curtains, tearing drops, or other defects and variations in a coating that causes the coating to be un-smooth as tested according to ASTM D4400 (2018). Sag can be measured in mm using a ruler. The drip or wing defect of a coating can be visible underneath a panel hole. ASTM D4400 suggests that the sag limit is 1.6 mm (distance between drawdown lines). As used herein, “no sag” refers to a situation where there is no visible drip or wing defect, “minimal sag” refers to a situation where there is no more than 5 mm drip or wing defect between drawdown lines.

As used herein the term “shear strain” refers to the deformation or flow of a coating composition in response to an applied shear stress.

As used herein the term “shear stress” refers to pressure applied to a surface of a coating composition.

As used herein the term “shear thinning” refers to the non-Newtonian behavior of fluids whose viscosity decreases under increasing shear stress.

As used herein, the term “stream” refers to a body of flowing liquid, in many cases a flowing coating composition.

As used herein, the term “silicone” and like terms refers to polysiloxane polymers, which are based on a structure that includes alternate silicon and oxygen atoms. As used herein, “silicone” and “siloxane” are used interchangeably.

As used herein, the term “silanol-functional silicone” and like terms refers to silicones that include silanol functional groups, —SiOH.

As used herein, the term “substrate” refers to an article surface to be coated and can refer to a coating layer disposed on an article that is also considered a substrate.

As used herein, the term “target area” means a portion of the surface area of any substrate that is to be coated in applying a coating composition, such as a first, a second or a third coating composition. The target area will often not include the entire surface area of a given substrate. The term “non-target area” means the remainder of the surface area of the substrate and includes all areas beyond the substrate. In applying multiple coating compositions, for each application of one coating composition, the target area and non-target areas can differ.

As used herein, the term “thermosetting” means a polymer or resin that has functional groups that react with functional groups in a crosslinking agent or another polymer or molecule to form a network material, irreversibly transforming the “soft” polymer to a more rigid form. Thermosetting in many cases refers to resins that “set” irreversibly upon curing or crosslinking, wherein the polymer chains of the resins are joined together by covalent bonds. Once cured or crosslinked, a thermosetting resin will not melt upon the application of heat and is insoluble in most organic solvents.

As used herein the term “thermoplastic” refers to polymers and resins that are not joined by covalent bonds and, thereby, can undergo liquid flow upon heating and can be soluble in certain solvents.

As used herein the term “tip speed” refers to the speed at which an applicator traverses across the surface of a substrate.

As used herein, the term “total solids” or “solids” or “solids content” refers to the solids content as determined in accordance with ASTM D2369 (2020).

As used herein, the term “use conditions” means all temperatures and pressures, including ambient pressures, such as 101.3 kPa (1 atm), and temperatures at which any coating composition is used, stored or applied, and can include temperatures as low as −10 °C and as high as 140 °C.

As used herein, the term “transfer efficiency” refers to the weight percent of a coating composition that is applied to a substrate as compared to the weight of the coating composition leaving an applicator according to ASTM D5286-20.

As used herein, the term “topcoat” refers to an uppermost coating layer that is applied over another coating layer such as a basecoat to provide a protective and/or decorative layer.

As used herein the terms “two-component”, “2-K” and “2-pack” refers to a coating composition that includes a first component that contains a crosslinkable resins and a second component that contains crosslinking agents, where the first and the second components are maintained separately prior to use. The crosslinkable resins and crosslinking agents are capable of reacting when combined to form a thermoset composition.

As used herein, the term “vehicle” is used in its broadest sense and includes all types of vehicles, such as but not limited to cars, mini vans, SUVs (sports utility vehicle), trucks, semi trucks; tractors, buses, vans, golf carts, motorcycles, bicycles, railroad cars, trailers, ATVs (all terrain vehicle); pickup trucks; heavy duty movers, such as, bulldozers, mobile cranes and earth movers; aircraft; boats; ships; and other modes of transport.

As used herein, unless otherwise stated, the term “viscosity” refers to a value determined at 25 °C and ambient pressure and reflects a fluid's resistance to flow when subjected to a shear stress and/or a shear strain.

As used herein, the term “volatile” refers to materials that are readily vaporizable under ambient conditions.

As used herein, the phrase “wt. %” refers to weight percent.

Recent advances in precision applicator technology, a nonlimiting example being EcoPaintJet available from Dürr Systems AG, provide applicators with the ability to apply coatings with nearly 100% transfer efficiency, without the need for masking, to achieve fine edge detail. Often, these applicators require an output, for proper jetting deposits, of at least 100 μm wet film coating thickness. Many vehicle applications require dry film thicknesses for waterborne basccoats of typically less than 20 μm, such as 12-15 μm. These requirements suggest a maximum solids volume from a precision applied waterborne basecoats of less than 15 wt. %.

One approach to satisfying this requirementcan be to reduce the solids of a known spray applied waterborne basecoat to 15 wt. % or less, however, the resulting Newtonian rheology of the coating results in undesirable performance, such as unacceptable sag when applied to vertical substrates.

This disclosure provides a pH sensitive latex, having a lower solids content that provides desirable shear thinning rheological behavior, minimizing the need for other rheology control additives to properly form smooth horizontal films and desirable vertical sag resistance.

The present disclosure provides coating compositions that include:
6 to 15 wt. %, such as 6 to 14 wt. % or 7 to 13 wt. % total solids, based on the weight of the coating composition;
15 to 70 wt. %, such as 20 to 65 wt. % or 25 to 60 wt. %, based on the total solids, of core-shell resin particles; and
50 to 550 g/L, such as 100 to 500 g/L, or 150 to 450 g/L volatile organic compound (VOC) content;

The coating composition can have a viscosity at 1000 s⁻¹ of from 30 to 110 mPa·s, such as 40 to 100 mPa·s, or 45 to 90 mPa·s and a viscosity at 0.1 s⁻¹ of greater than 1000 mPa·s, such as greater than 2500 mPa·s or greater than 4000 mPa·s and can be up to 50,000 mPa·s measured using an Anton-Paar MCR301 rheometer equipped with a concentric cylinder fixture (CC27 with bob diameter of 26.66 mm, cup diameter of 28.92 mm and gap size of 1.13 mm) at 25 °C and a pressure of 101.3 kPa (1 atm). The total solids and VOC are determined according to ASTM D3960 (2005). As a nonlimiting example, the coating composition can be applied using a high transfer efficiency precision applicator.

The core-shell resin particles can include polymeric microparticles or nanoparticles that have a core/shell structure. The core (interior domain) and shell (surface domain) polymers may be chemically conjugated, physically associated and/or covalently attached to each other, and the polymeric particles can be formed by step-wise emulsion polymerization of ethylenically unsaturated monomers. Non limiting examples of polymerization methods are demonstrated in the examples below. The core can include from 2 to 98 wt. %, such as 65 to 90 wt. %, or from 75 to 85 wt. % of the polymeric microparticle, while the shell can make up from 2 to 98 wt. %, such as 10 to 35 wt. %, or from 15-25 wt. % of the polymeric particle. Also, the core may be internally crosslinked through the use of monomers having multiple ethylenically unsaturated groups, a nonlimiting example being ethylene glycol dimethacrylate. These internally crosslinking monomers can be used in amounts of up to 10 wt. %, such as 3-10 percent wt. %. The shell polymer can be designed to be more polar than the core by using polar monomers having functional groups, nonlimiting examples being hydroxyl and acid groups. As a nonlimiting example, the shell polymer can be formed from acid functional ethylenically unsaturated monomers in an amount sufficient to allow for dispersion of the polymeric particles in an aqueous medium. The monomers having functional groups can be included in the monomer solution used to form the shell at from 20 to 40 wt. %, such as from 25 to 35 wt. % of monomers used to prepare the shell.

As a nonlimiting example, the core-shell resin particles described above can include a core-shell resin particle that when dispersed in an aqueous medium at a solids content of greater than 0 wt. % to less than 14 wt. %, such as 1 wt. % to 13 wt. %, 2 wt. % to 13 wt. % or 3 wt. % to 12 wt. % at a pH of 8 to 8.7, such as 8.2 to 8.6 or 8.3 to 8.5 can form a viscoelastic gel having a G′ value greater than a G″ value measured at ω=1 rad/s and γ=1% using an Anton-Paar MCR301 rheometer equipped with a 50-millimeter cone and plate fixture at 25 °C and a pressure of 101.3 kPa (1 atm). Described another way, the loss modulus, tan (δ) (tan (δ)=G″/G′) becomes less than 1.

As a nonlimiting example, the core-shell resin particles can include
a core derived from polymerizing a monomer mixture that includes
   0 to 99 wt. %, such as 95 to 99 wt. % or 96 to 99 wt. % of first nonionic monomers conforming to the formula:

R¹₂C═CR¹—C(O)—W—R⁶
where each R¹ is independently —H, —CH₃ or —CH₂CH₃;
W is selected from O, NR⁴, and S; each R¹ is independently —H, —CH₃ or —CH₂CH₃;
R⁴ is H, CH₃ or CH₂CH₃; and
R⁶ is selected from C₁ to C₁₂ alkyl, C₅ to C₁₂ cycloaliphatic, and C₆ to C₁₂ aromatic or alkyl aromatic and can optionally include-OH substitution for one or more hydrogens;
0 to 4 wt. %, such as 1 to 4 wt. % or 1 to 3 wt. % carboxylic monomers conforming to the formula:

R²₂C═CR²—C(O)—OH
where each R² is independently —H, —CH₃ or —CH₂CH₃; and
0 to 100 wt. %, such as 20 to 90 wt. % or 20 to 80 wt. % vinyl monomers conforming to the formula:

R¹₂C═CR¹-A-C(O)—R⁹
where each R¹ is independently —H, —CH₃ or —CH₂CH₃; A is NR⁴ or O;
R⁴ is H, CH₃ or CH₂CH₃; and
R⁹ is a linear or branched alkyl group having 1 to 18 carbon atoms, or R⁹ is bonded to A to form a 5- to 7-member ring when A is nitrogen;
a shell derived from a monomer mixture comprising
   0 to 40 wt. %, such as 2 to 30 wt. %, or 5 to 20 wt. % second nonionic monomers conforming
   to the formula:

R¹₂C═CR¹—C(O)—Z—R⁷
where each R¹ is independently —H, —CH₃ or —CH₂CH₃;
Z is selected from O, NR⁴, S and a group according to the formula

(O—CR⁸—CR⁸—)ₙ—O—
where each R⁸ is independently —H, —CH₃ or —CH₂CH₃; and n is 0 to 30, such as 0 to 25 or 1 to 25;
R⁷ is selected from C₁ to C₁₈ alkyl, C₅ to C₁₂ cycloaliphatic, and C₆ to C₁₈ aromatic or alkyl aromatic and can optionally include-OH substitution for one or more hydrogens;
R⁴ is H, CH₃ or CH₂CH₃; and
2 to 50 wt. %, such as 20 to 50 wt. %, 15 to 50 wt. %, or 15 to 40 wt. % carboxylic monomers conforming to the formula:

R²₂C═CR²—C(O)—OH
where each R² is independently —H, —CH₃ or —CH₂CH₃; and
0 to 50 wt. %, such as 0 to 40 wt. % or 10 to 40 wt. % vinyl monomers conforming to the formula:

R¹₂C═CR¹-A-C(O)—R⁹
where each R¹ is independently —H, —CH₃ or —CH₂CH₃;
A is NR⁴ or O;
R⁴ is H, CH₃ or CH₂CH₃; and
R⁹ is a linear or branched alkyl group having 1 to 18 carbon atoms, or R⁹ is bonded to A to form a 5- to 7-member ring when A is nitrogen.

As a nonlimiting example, after the vinyl monomers conforming to the formula:

R¹₂C═CR¹-A-C(O)—R⁹
are incorporated into either or both of the core or shell of the core-shell resin particles, the incorporated residues can be hydrolyzed to leave a hydroxyl group (if A is oxygen) or amine group (if A is nitrogen).

As nonlimiting examples, the first nonionic monomers can be selected from alkyl esters of (meth)acrylic acid. Nonlimiting examples of suitable (meth)acrylic esters include ethyl (meth)acrylate, propyl (meth)acrylate, n-butyl (meth)acrylate, isobutyl (meth)acrylate, tert-butyl (meth)acrylate, 2-ethylhexyl (meth)acrylate, lauryl (meth)acrylate; cyclic esters such as cyclohexyl (meth)acrylate, isobornyl (meth)acrylate.

As nonlimiting examples, the first nonionic monomers can be selected from amides and alkyl amides of (meth)acrylic acid. Nonlimiting examples of suitable (meth)acrylic amides include (meth)acrylamide, N-methyl (meth)acrylamide, N-ethyl (meth)acrylamide, N,N-dimethyl (meth)acrylamide, N-propyl (meth)acrylamide, N-n-butyl (meth)acrylamide, N-isobutyl (meth)acrylamide, N-tert-butyl (meth)acrylamide, N-2-ethylhexyl (meth)acrylamide, N-lauryl (meth)acrylamide; N-cyclohexyl (meth)acrylamide, and N-isobornyl (meth)acrylamide.

Combinations of any of the monomers indicated above can be used as the first nonionic monomers.

As nonlimiting examples, the carboxylic monomers can be selected from acrylic acid, α-methacrylic acid, β-methacrylic acid, 2-ethyl-prop-2-enoic acid, 1-ethyl-prop-2-enoic acid, α,α-dimethyl acrylic acid, β,β-dimethyl acrylic acid, α,β-dimethyl acrylic acid and combinations thereof.

As nonlimiting examples, the vinyl monomers can be selected from vinyl acetate, vinyl formate, vinyl proprionate, N-vinylacetamide N-methyl-N-vinylacetamide, N-vinylformamide, N-methyl-N-vinylformamide, 2-ethyl-5-methyl-5-vinyl-tetrahydrofuran, 5-vinyl-tetrahydrofuran, 2-methyl-2-vinyl-tetrahydrofuran and combinations thereof.

As nonlimiting examples, the second nonionic monomers can be selected from ethyl (meth)acrylate; propyl (meth)acrylate; n-butyl (meth)acrylate; isobutyl (meth)acrylate; tert-butyl (meth)acrylate; 2-ethylhexyl (meth)acrylate; lauryl (meth)acrylate; cyclohexyl (meth)acrylate; isobornyl (meth)acrylate; (meth)acrylamide; N-methyl (meth)acrylamide; N-ethyl (meth)acrylamide; N,N-dimethyl (meth)acrylamide; N-propyl (meth)acrylamide; N-n-butyl (meth)acrylamide; N-isobutyl (meth)acrylamide; N-tert-butyl (meth)acrylamide; N-2-ethylhexyl (meth)acrylamide; N-lauryl (meth)acrylamide; N-cyclohexyl (meth)acrylamide; N-isobornyl (meth)acrylamide; and alkyl polyalkylene glycol (meth)acrylates where the alkyl group can be a linear, branched or cyclic alkyl group of from 1 to 22, such as 2 to 20 or 4 to 18 carbons and the polyalkylene glycol has from 1 to 40, such as 2 to 30, or 4 to 25 repeat units selected from ethylene glycol, propylene glycol, butylene glycol, hexane diol and combinations thereof.

As a nonlimiting example, the coating compositions described herein can include an aqueous carrier. When the coating compositions include an aqueous carrier, the coating composition can include from 60 to 93 wt. %, such as 70 to 90 wt. % or 80 to 90 wt. % water.

As a nonlimiting example, the coating compositions described herein can have a pH of from 7.5 to 10, such as 7.6 to 9.6, 8 to 8.7 or 8.5 to 8.7. As a nonlimiting example, the carboxylic acid functional groups in the core-shell resin particles can be at least partially neutralized (i.e., at least 30% of the total neutralization equivalent) by a base, such as a volatile amine, to form a salt group. A volatile amine refers as an amine compound having an initial boiling point of less than or equal to 250 °C as measured under standard conditions. Nonlimiting examples of suitable volatile amines include ammonia, dimethylamine, trimethylamine, monoethanolamine, and dimethylethanolamine.

Not being bound to any single theory, increasing the pH of the dispersion causes the shell of the core-shell resin particles to swell and enables it to desirably modify the rheology of the coating compositions.

An aim of the coating compositions according to this disclosure is to minimize or eliminate the inclusion of rheology modifiers. When included in the coating compositions, the coating compositions can include rheology modifiers. Non-limiting examples of suitable rheology modifiers include, thixotropic agents such as bentonite clay, urea-containing compounds, layered silicate solutions and gels in propylene glycol, acrylic alkali swellable emulsions (ASEs), associative thickeners, such as nonionic hydrophobically modified ethylene oxide urethane block copolymers (referred to herein as “HEUR”) or hydrophobically modified acrylic alkali swellable emulsions (HASEs), hydrophobically-modified hydroxy ethyl cellulose (HMHEC), copolymers of ethylene and vinyl acetate (EVA wax) and combinations thereof. The coating composition may include the rheology modifier in an amount of up to 20 wt. % of the total solids of a coating composition, or from 0.01 to 10, alternatively from 0.05 to 5, or alternatively from 0.05 to 0.1, wt. %, based on the total weight of the coating composition. Suitable coating compositions may include a layered silicate propylene glycol solution, an ASE, or a combination thereof. The layered silicate propylene glycol solution includes a synthetic layered silicate, water, and polypropylene glycol. Nonlimiting examples of a suitable synthetic layered silicate include LAPONITE™ RD, LAPONITE™ RDS, LAPONITE™ S482 and LAPONITE™ SL25 layered silicate compositions (Altana AG of Wesel, DE). A nonlimiting example of a suitable ASE is a VISCALEX™ HV 30 (BASF Corporation of Florham Park, NJ).

Suitable coating compositions can include hydrophobically modified ethoxylated urethane (HEUR) associative thickeners, which can be a linear and branched HEUR formed by reacting a polyglycol, a hydrophobic alcohol, a diisocyanate, and a triisocyanate together in a one-pot reaction, a nonlimiting example of which is described in U.S. Patent Application Publication 2009/0318595A1 to Steinmetz et al.; or those formed by polymerizing in a solvent-free melt, in the presence of a catalyst, such as bismuth octoate, of a polyisocyanate branching agent, a water-soluble polyalkylene glycol having an Mw (GPC using polyethylene glycol standards) of from 2000 to 11,000 g/mol, and a diisocyanate as described in U.S. Pat. No. 9,150,683 to Bobsein et al. The hydrophobic alcohol used to make a HEUR can include, as a nonlimiting example, alcohols having a carbon number ranging from 3 to 24, such as from 5 to 20, or from 10 to 25, such as octanol, dodecanol, tetradecanol, hexadecanol, cyclohexanol, phenol, cresol, octylphenol, nonyl phenol, dodecyl phenol, tristyrylphenol, ethoxylated tristyrylphenol, monomethyl ethers of ethylene glycol, monoethyl ethers of ethylene glycol, monobutyl ethers of ethylene glycol, monomethyl ethers of ethylene diethylene glycol, monoethyl ethers of diethylene glycol, monobutyl ethers of diethylene glycol; alkyl and alkaryl polyether alcohols such as straight or branched alkanol/ethylene oxide and alkyl phenol/ethylene oxide adducts, for example, the lauryl alcohol, t-octylphenol or nonylphenolethylene oxide adducts containing 1-250 ethylene oxide groups; and other alkyl, aryl and alkaryl hydroxyl compounds, or combinations thereof. The branching agent can include, as a nonlimiting example, triisocyanates, such as 1,6,11-undecane triisocyanate; isocyanurates, such as isophorone diisocyanate isocyanurate; and biurets, such as tris(isocyanatohexyl) biuret; the hydrophobic capping agent can include, as nonlimiting examples, at least one of n-octanol, n-nonanol, n-decanol, n-undecanol, n-dodecanol, 2-ethylhexanol, 2-butyl-1-octanol, or 3,7-dimethyl-1-octanol.

As nonlimiting examples, when included, the rheology modifier can be selected from inorganic thixotropic agents, an acrylic alkali swellable emulsion (ASE), a hydrophobically modified ethylene oxide urethane block copolymer (HEUR), hydrophobically-modified, alkali swellable emulsions (HASE) and hydrophobically-modified hydroxy ethyl cellulose (HMHEC), copolymers of ethylene and vinyl acetate (EVA wax), and mixtures thereof.

When included in the coating compositions, the rheology modifier can be included in an amount of from 0 to 10 wt. %, such as 1 to 9 wt. % or 1 to 7.5 wt. % based on the total solids of the coating composition.

The coating compositions described herein can include a film-forming polymer or resin that includes at least one crosslinking-functional group and a crosslinking material that includes at least one functional group reactive with the crosslinking-functional group.

In many cases, the polymers and resins can have crosslinkable functional groups. Nonlimiting examples of suitable crosslinkable functional groups include carbamate, carboxylic acid, alkoxy silanes, hydroxyl groups, carboxyl groups, epoxy groups, UV curable functional groups and combinations thereof. The polymers and resins can be used alone, or two or more can be used in combination. As a nonlimiting example, when included in the coating composition, the film-forming polymer or resin includes a crosslinking-functional group selected from hydroxyl groups, carboxyl groups and amine groups.

The polymers and resins included as film-forming constituents in the coating composition include those commonly used in coating compositions. Nonlimiting examples of suitable polymers and resins include acrylic resins, polyester resins, alkyd resins, polyurethane resins, polyolefin resins, silanes, epoxy and siloxane resins and combinations thereof. The polymers and resins included as film-forming constituents in the coating composition can have a number average molecular weight of at least 250 g/mol, such as at least 500 g/mol, at least 750 g/mol, and at least 1,000 g/mol and can be up to 500,000 g/mol, such as up to 100,000 g/mol, up to 50,000 g/mol, up to 20,000 g/mol and up to 10,000 g/mol and can be from 250 g/mol to 500,000 g/mol, such as 500 g/mol to 500,000 g/mol, 750 g/mol to 500,000 g/mol, 1,000 g/mol to 500,000 g/mol, 250 g/mol to 100,000 g/mol, 500 g/mol to 100,000 g/mol, 750 g/mol to 100,000 g/mol, 1,000 g/mol to 100,000 g/mol, 250 g/mol to 50,000 g/mol, 500 g/mol to 50,000 g/mol, 750 g/mol to 50,000 g/mol, 1,000 g/mol to 50,000 g/mol, 250 g/mol to 20,000 g/mol, 500 g/mol to 20,000 g/mol, 750 to 20,000 g/mol, 1,000 g/mol to 20,000 g/mol, 250 g/mol to 10,000 g/mol, 500 g/mol to 10,000 g/mol, 750 to 10,000 g/mol, 1,000 to 10,000 g/mol. The weight average molecular weight of polymers and resins included as film-forming constituents in the coating composition can be at least 500 g/mol, such as at least 800 g/mol, at least 1,200 g/mol and at least 2,000 g/mol and can be up to 500,000 g/mol, such as up to 200,000 g/mol and up to 50,000 g/mol and from 500 g/mol to 500,000 g/mol, such as 800 g/mol to 500,000 g/mol, 1,200 to 500,000 g/mol, 2,000 to 500,000 g/mol, 500 g/mol to 200,000 g/mol, 800 g/mol to 200,000 g/mol, 1,200 g/mol to 200,000 g/mol, 2,000 g/mol to 200,000 g/mol, 500 g/mol to 50,000 g/mol, 800 g/mol to 50,000 g/mol, 1,200 g/mol to 50,000 g/mol, and 2,000 g/mol to 50,000 g/mol. The number average molecular weight and weight average molecular weight of polymers and resins included as film-forming constituents in the coating composition can be any value or range between (and include) any of the values recited above.

One suitable class of film-forming polymer for the film-forming resins includes, but is not limited to, those which are derived from ethylenically unsaturated monomers. Particularly useful members of this class are the acrylic polymers, such as polymers or copolymers of alkyl esters of (meth)acrylic acid, optionally together with other ethylenically unsaturated monomers. These polymers can be thermosetting and crosslinkable. Suitable (meth)acrylic esters include, but are not limited to, ethyl (meth)acrylate, propyl (meth)acrylate, n-butyl (meth)acrylate, isobutyl (meth)acrylate, tert-butyl (meth)acrylate, 2-ethylhexyl (meth)acrylate, lauryl (meth)acrylate. Cyclic esters such as cyclohexyl (meth)acrylate, isobornyl (meth)acrylate as well as hydroxyalkyl esters such as 2-hydroxy (meth)ethyl acrylate, 2-hydroxypropyl (meth)acrylate can also be used. In addition, vinyl aliphatic or vinyl aromatic compounds such as (meth)acrylonitrile, styrene, vinyl acetate, vinyl propionate and vinyl toluene can be used. For crosslinking, suitable functional monomers to be used in addition to the aforementioned include (meth)acrylic acid, hydroxyethyl (meth)acrylate, 2-hydroxypropyl (meth)acrylate, N-(alkoxymethyl) and (meth)acrylamides where the alkoxy group can be, as a nonlimiting example, a butoxy group, glycidyl acrylate, and/or glycidyl methacrylate.

As a nonlimiting example, the film-forming resins can include polyester polyols, which can be prepared in a known manner by condensation of polyhydric alcohols and polycarboxylic acids. Suitable polyhydric alcohols include ethyleneglycol, propylene glycol, butylene glycol, 1,6-hexyleneglycol, neopentyl glycol, diethylene glycol, glycerol, trimethylol propane, and pentaerythritol. Suitable polycarboxylic acids include succinic acid, adipic acid, azelaic acid, sebacic acid, maleic acid, fumaric acid, phthalic acid, tetrahydrophthalic acid, hexahydrophthalic acid and trimellitic acid. In addition to the polycarboxylic acids mentioned above, functional equivalents of the acids such as anhydrides where they exist or C₁-C₆ alkyl esters of the acids such as the methyl esters may be used.

As a nonlimiting example, the film-forming resins can include acrylic polyols, which can be prepared from a monomer mixture that includes a hydroxyl functional monomer. Mixtures of different acrylic polyols can be used. The hydroxyl functional monomer can include a hydroxyalkyl group. Suitable acrylic polyols include copolymers of alkyl esters of (meth)acrylic acid optionally together with other polymerizable ethylenically unsaturated monomers.

Nonlimiting examples of hydroxyl functional monomers that can be used in the acrylic polyols include hydroxyalkyl (meth)acrylates, typically having 2 to 12 carbon atoms in the hydroxyalkyl group, such as hydroxyethyl (meth)acrylate, hydroxypropyl (meth)acrylate, 4-hydroxybutyl (meth)acrylate, 5-hydroxypentyl (meth)acrylate, 6-hydroxyhexyl (meth)acrylate, 8-hydroxyoctyl (meth)acrylate, 9-hydroxynonyl (meth)acrylate, 10-hydroxydecyl (meth)acrylate, 11-hydroxyundecyl (meth)acrylate, 12-hydroxydodecyl (meth)acrylate, and the like; (4-(hydroxymethyl)cyclohexyl)methyl (meth)acrylate; hydroxy functional adducts of caprolactone and hydroxyalkyl (meth)acrylates, as well as the beta-hydroxy ester functional monomers, the reaction product of glycidyl methacrylate and versatic acid and the reaction product of Cardura™ E10p glycidyl ester (available from Hexion) reacted with methacrylic acid. The hydroxyl functional monomer can be included in the monomer mixture in an amount of at least 5 wt. %, such as at least 10 wt. % and at least 15 wt. %, and can be up to 70 wt. %, up to 60 wt. %, up to 50 wt. %, up to 45 wt. % and up to 40 wt. % and can be from 5 to 70 wt. %, such as 10 to 70 wt. %, 15 to 70 wt. %, 5 to 60 wt. %, 10 to 60 wt. %, 15 to 60 wt. %, 5 to 50 wt. %, 10 to 50 wt. %, 15 to 50 wt. %, 5 to 40 wt. %, 10 to 40 wt. %, and 15 to 40 wt. % based on the total weight of monomers in the monomer mixture used to prepare the acrylic polyol. The amount of hydroxyl functional monomers used in the acrylic polyols can be any value or range between (and include) any of the values recited above.

The acrylic polyol can have a weight average molecular weight of at least 1,000 g/mol, such as at least 2,000 g/mol, at least 3,000 g/mol, at least 5,000 g/mol, and at least 5,500 g/mol, and can be up to 50,000 g/mol, such as up to 30,000 g/mol, up to 15,000 g/mol, up to 10,000 g/mol and up to 7,500 g/mol and can be from 1,000 g/mol to 50,000 g/mol, such as 1,000 g/mol to 30,000 g/mol, 1,000 g/mol to 15,000 g/mol, 1,000 g/mol to 10,000 g/mol, 1,000 g/mol to 7,500 g/mol, 2,000 g/mol to 50,000 g/mol, 2,000 g/mol to 30,000 g/mol, 2,000 g/mol to 15,000 g/mol, 2,000 g/mol to 10,000 g/mol, 2,000 g/mol to 7,500 g/mol, 3,000 g/mol to 50,000 g/mol, 3,000 g/mol to 30,000 g/mol, 3,000 g/mol to 15,000 g/mol, 3,000 g/mol to 10,000 g/mol, 3,000 g/mol to 7,500 g/mol, 5,000 g/mol to 50,000 g/mol, 5,000 g/mol to 30,000 g/mol, 5,000 g/mol to 15,000 g/mol, 5,000 g/mol to 10,000 g/mol, and 5,000 g/mol to 7,500 g/mol. The weight average molecular weights as reported herein can be determined by gel permeation chromatography (GPC) using appropriate polystyrene standards. The weight average molecular weight of the acrylic polyols can be any value or range between (and include) any of the values recited above.

Useful alkyl esters of (meth)acrylic acid include, but are not limited to, aliphatic alkyl esters containing from 1 to 30, and often 2 to 18 carbon atoms in the alkyl group. Non-limiting examples include methyl (meth)acrylate, ethyl (meth)acrylate, butyl (meth)acrylate, and 2-ethylhexyl (meth)acrylate. Suitable other copolymerizable ethylenically unsaturated monomers include vinyl aromatic compounds such as styrene and vinyl toluene; nitriles such as (meth)acrylonitrile; vinyl and vinylidene halides such as vinyl chloride and vinylidene fluoride and vinyl esters such as vinyl acetate.

The film forming resins can include polyesters and polyesters functionalized with carbamate.

Nonlimiting examples of suitable crosslinking agents include: diisocyanate, dihydrazides, diepoxide, and condensates of formaldehyde with a nitrogenous compound such as urea, thiourea, melamine or benzoguanamine, or lower alkyl ethers of such condensates in which the alkyl group typically contains from 1 to 4 carbon atoms, typically referred to as an aminoplast. Other nonlimiting examples of crosslinking agents are melamine-formaldehyde condensates (melamine resins) in which a substantial proportion of the methylol groups have been etherified by reaction with butanol or alcohols like ethanol or methanol, carbodiimides, polyols, phenolic resins, epoxy resins, beta-hydroxy (alkyl) amide resins, hydroxy (alkyl) urea resins, oxazoline, alkylated carbamate resins, (meth)acrylates, isocyanates, blocked isocyanates, polyacids, anhydrides, organometallic acid-functional materials, polyamines, polyamides, aziridines, and combinations thereof.

As a nonlimiting example, the crosslinking material can include a melamine resin.

Any of these crosslinking agents known to those skilled in the art for use with curable acrylic polymers can be used. For the purposes of the foregoing, the crosslinking agent, where present, can be considered as being a part of the film-forming resin material.

Other nonlimiting examples of suitable classes of polymers useful as the curable film-forming resins are:
(i) a polyepoxide and a polyacid crosslinking agent;
(ii) a (meth)acrylosilane polymer, a (meth)acrylic polyol polymer, and an alkylated melamine-formaldehyde crosslinking agent; and
(iii) a polyisocyanate and a polymer having a group that can be reactive with isocyanate.

Nonlimiting examples of polyisocyanates include aliphatic and aromatic polyisocyanate and mixtures thereof. As particular nonlimiting examples, higher polyisocyanates such as isocyanurates of diisocyanates can be used; diisocyanates, uretdione and biuret can also be used. Isocyanate prepolymers, nonlimiting examples including the reaction products of polyisocyanates with polyols also can be used. Mixtures of polyisocyanate crosslinking agents can be used.

As nonlimiting examples, the polyisocyanate can be prepared from a variety of isocyanate-containing materials. Nonlimiting examples of suitable polyisocyanates include trimers prepared from the following diisocyanates: toluene diisocyanate, 4,4′-methylene-bis(cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used.

Isocyanate groups can be capped or uncapped as desired. If the polyisocyanate is to be blocked or capped, any suitable aliphatic, cycloaliphatic, or aromatic alkyl monoalcohol or phenolic compound known to those skilled in the art can be used as a capping agent for the polyisocyanate. Nonlimiting examples of suitable blocking agents include those materials which would unblock at elevated temperatures such as aliphatic alcohols including methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers can also be used as capping agents. Nonlimiting examples of suitable glycol ethers include ethylene glycol butyl ether, diethylene glycol butyl ether, ethylene glycol methyl ether and propylene glycol methyl ether. Nonlimiting examples of other suitable capping agents include oximes such as methyl ethyl ketoxime, acetone oxime and cyclohexanone oxime, lactams such as epsilon-caprolactam, pyrazoles such as dimethyl pyrazole, and amines such as dibutyl amine.

The amount of film-forming resin in the coating composition typically includes any film-forming polymers and crosslinking agents included in the coating composition. The amount of film-forming resins in the coating composition can be at least 0.1 wt. %, such as at least 0.5 wt. %, at least 1 wt. %, at least 5 wt. %, at least 10 wt. %, at least 15 wt. % and at least 20 wt. % and can be up to 95 wt. %, such as up to 93 wt. %, up to 90 wt. %, and up to 87 wt. % and can be from 0.1 wt. % to 95 wt. %, such as 0.5 wt. % to 95 wt. %, 1 wt. % to 95 wt. %, 5 wt. % to 95 wt. %, 10 wt. % to 95 wt. %, 15 wt. % to 95 wt. %, 20 wt. % to 95 wt. %, 1 wt. % to 90 wt. %, 5 wt. % to 90 wt. %, 10 wt. % to 90 wt. %, 15 wt. % to 90 wt. %, 20 wt. % to 90 wt. %, 1 wt. % to 87 wt. %, 5 wt. % to 87 wt. %, 10 wt. % to 87 wt. %, 15 wt. % to 87 wt. % and 20 wt. % to 87 wt. % based on the total solids of the coating composition. If the amount of film-forming resin is too low, the final coating may not have desired properties and if the amount of film-forming resin is too high, it may the coating composition may not have a desired rheological profile. The amount of film-forming resin in the coating composition can be any value or range between (and include) any of the values recited above. The number average and weight average molecular weight for the film forming resins is as recited above.

As a nonlimiting example, when included in the coating composition, the crosslinking material can be present at from 1 to 30 wt. %, such as 5 to 30 wt. % or 10 to 30 wt. % based on the total solids of the coating composition. The film-forming polymer or resin that includes at least one crosslinking-functional group can be present at from 1 to 40 wt. %, such as 5 to 40 wt. % or 10 to 40 wt. %.

The coating compositions described herein can be thermosetting compositions.

The coating compositions described herein can include adhesion promoters. Specific adhesion promotors can be selected for preferred performance with a particular substrate, nonlimiting examples being metal or plastic. In nonlimiting examples, the adhesion promoter includes a free acid, which can include organic and/or inorganic acids that are included as a separate component of the coating compositions as opposed to any acids that can be used to form a polymer that can be present in the coating composition. The free acid can include tannic acid, gallic acid, phosphoric acid, phosphorous acid, citric acid, malonic acid, a derivative thereof, or mixtures thereof. Suitable derivatives include esters, amides, and/or metal complexes of such acids. Often, the free acid includes a phosphoric acid, such as a 100 percent orthophosphoric acid, superphosphoric acid or the aqueous solutions thereof, such as a 70 to 90 percent phosphoric acid solution. Nonlimiting examples of other suitable adhesion promoting components include metal phosphates, organophosphates, and organophosphonates and metal phosphates including zinc phosphate, iron phosphate, manganese phosphate, calcium phosphate, magnesium phosphate, cobalt phosphate, zinc-iron phosphate, zinc-manganese phosphate, zinc-calcium phosphate. Other nonlimiting examples of adhesion promoters include phosphatized epoxy resins that can include the reaction product of epoxy-functional materials and phosphorus-containing materials. Additional nonlimiting examples of adhesion promoters include alkoxysilane adhesion promoting agents such as acryloxyalkoxysilanes, such as γ-acryloxypropyltrimethoxysilane and methacrylatoalkoxysilane, γ-methacryloxypropyltrimethoxysilane, γ-glycidoxypropyltrimethoxysilane, γ-methacryloxypropylmethyldimethoxysilane, 3-acryloxypropyltrimethoxysilane, vinyltrimethoxysilane, vinyltriethoxysilane, p-styryltrimethoxysilane, 2-(3,4-epoxycyclohexyl)ethyltrimethoxysilane, γ-glycidoxypropylmethyldimethoxysilane, 3-glycidoxypropylmethyldiethoxysilane, γ-aminopropyltrimethoxysilane, 3-aminopropyltriethoxysilane, N-2(aminoethyl) 3-amino-propylmethyldimethoxysilane, N-2(aminoethyl) 3-amino-propyltrimethoxysilane, N-2(aminoethyl) 3-aminopropyltriethoxysilane, 3-mercaptopropylmethyldimetoxysilane, 3-mercaptopropyltrimethoxysilane and siloxane borates.

The present disclosure provides a method of forming a coating layer on at least a portion of a substrate that includes applying any of the coating compositions described herein to a substrate using a high transfer efficiency applicator.

As a nonlimiting example, the high transfer efficiency applicator includes a nozzle orifice that expels the coating composition as a droplet or jet as it is expelled from the nozzle orifice.

The high transfer efficiency applicator can include multiple nozzles and each nozzle capable of expelling the coating composition to form a jet having the form of a line segment, a planar jet or lamina, a hollow cylindrical jet, or where the nozzles cooperatively expel the coating composition to form a liquid sheet.

The disclosure is also directed to methods of forming a coating layer on, at least a portion of a substrate. The methods include, but are not limited to, allowing any of the coating compositions described herein to flow through one or more applicators that include one or more nozzles capable of applying a shear stress on the coating composition. When the coating composition is exposed to the high shear stress in the nozzle, its viscosity is decreased as described herein as it flows through the nozzle. The coating composition can either form a continuous stream or discrete droplets as it exits the nozzle. When the coating composition contacts the substrate, it forms a uniform coating.

The coating compositions can be applied over a substrate positioned substantially horizontal relative to the ground. As used herein, a substrate positioned “substantially horizontal relative to the ground” refers to a substrate having at least a portion of the surface being coated being parallel to or within 10°, such as within 5°, of being parallel to the ground.

The coating compositions can be applied over a substrate positioned substantially vertical relative to the ground. As used herein, a substrate positioned “substantially vertical relative to the ground” refers to a substrate having at least a portion of the surface being coated being perpendicular to or within 45°, such as within 40°, within 30°, within 20°, within 10°, or within 5°; of being perpendicular to the ground.

The coating compositions can have a surface tension such that the difference in the surface energy of the substrate and the surface tension of the coating composition, not coated or having a coating layer applied thereto (surface energy substrate-surface tension of coating composition), can be greater than 0, such as greater than 0.5 mN/m, greater than 0.7 mN/m, greater than 1 mN/m and greater than 2 mN/m as determined according to DIN EN 14370:2004-11 (Surface active agents-Determination of surface tension; German version DIN EN 14370; 2004-11) and the surface tension of the surface of the substrate can be determined according to DIN EN ISO 19403-2:2020-04 (Wettability-Part 2; Determination of the surface free energy of solid surfaces by measuring the contact angle). Not being bound to a particular theory, the difference in surface tensions is believed to contribute, at least in part, to the coating composition being suitable for application with precision application devices that can apply the coating composition without overspray.

The coating composition can be applied over at least a portion of a substrate, whether not coated or at least partially having a coating layer applied thereto, to form a coating layer, nonlimiting examples including a primer coat layer, a basecoat layer, a clearcoat layer and a topcoat layer. Additionally, any of the coating compositions can be a one-component (1-K), two-component (2-K) or multi-component coating composition.

As a nonlimiting example, the methods according to this disclosure include applying a primer layer on the substrate prior to applying the coating composition. As a further nonlimiting example, multiple coating layers can be applied to the substrate prior to applying the coating compositions of this disclosure. As nonlimiting examples, the multiple coating layers can be selected from primer layer, basecoat, topcoat and clearcoat.

The substrate over which the coating composition can be applied includes a wide range of substrates. As a nonlimiting example, the coating composition can be applied to a vehicle substrate, an industrial substrate, an aerospace substrate, and the like. As a nonlimiting example, the substrate can be a vehicle or a portion thereof.

As a nonlimiting example, the substrate can include a polymer or a composite material such as a fiberglass composite. Vehicle parts typically formed from thermoplastic and thermoset materials include bumpers and trim.

Nonlimiting examples of substrates to which the coating compositions can be applied include rigid metal substrates such as ferrous metals, aluminum, aluminum alloys, copper, and other metal and alloy substrates. The ferrous metal substrates can include iron, steel, and alloys thereof. Non-limiting examples of useful steel materials include cold rolled steel, galvanized (zinc coated) steel, electrogalvanized steel, stainless steel, pickled steel, zinc-iron alloys, and combinations thereof. Combinations or composites of ferrous and non-ferrous metals can also be used.

Nonlimiting examples of steel substrates (such as cold rolled steel or any of the steel substrates listed above) include those coated with a weldable, zinc-rich or iron phosphide-rich organic coating. Cold rolled steel can also suitable when pretreated with an appropriate solution known in the art, such as a metal phosphate solution, an aqueous solution containing a Group IIIB or IVB metal, an organophosphate solution, an organophosphonate solution, and combinations thereof, as discussed below. Nonlimiting examples of aluminum alloys include those alloys used in the automotive or aerospace industry, such as 2000, 6000, or 7000 series aluminums; 2024, 7075, 6061 are particular examples. Alloys can be unclad or they can contain a clad layer on a surface, the clad layer consisting of a different aluminum alloy than the base/bulk alloy beneath the clad layer.

Nonlimiting examples of substrates include more than one metal or metal alloy in that the substrate can be a combination of two or more metal substrates assembled together such as hot-dipped galvanized steel assembled with aluminum substrates.

Nonlimiting examples of the shape of the metal substrate include in the form of a sheet, plate, bar, rod or any shape desired, but it in many cases it can be in the form of an automobile part, such as a body, door, trunk lid, fender, hood or bumper. The thickness of the substrate can vary as desired.

The coating can be applied directly to the metal substrate when there is no intermediate coating between the substrate and the coating composition. By this is meant that the substrate can be bare, as described below, or can be treated with a pretreatment composition as described below, but the substrate is not coated with any coating compositions such as an electrodepositable composition or a primer composition prior to application of the curable film-forming composition described herein.

As noted above, the substrates to be used can be bare metal substrates, in other words, a virgin metal substrate that has not been treated with any pretreatment compositions such as conventional phosphating baths, heavy metal rinses, etc. Additionally, bare metal substrates that can be used herein can be a cut edge of a substrate that is otherwise treated and/or coated over the rest of its surface. Alternatively, the substrates can undergo treatment steps known in the art prior to the application of the coating composition.

The substrate can be cleaned using conventional cleaning procedures and materials. Nonlimiting examples include mild or strong alkaline cleaners such as are commercially available and conventionally used in metal pretreatment processes. Such cleaners are generally followed and/or preceded by a water rinse. The metal surface can also be rinsed with an aqueous acidic solution after or in place of cleaning with the alkaline cleaner. Nonlimiting examples of rinse solutions include mild or strong acidic cleaners such as the dilute nitric acid solutions commercially available and conventionally used in metal pretreatment processes.

According to the compositions, methods, systems and substrates herein, at least a portion of a cleaned aluminum substrate surface can be deoxidized, mechanically or chemically, in other words removal of the oxide layer found on the surface of the substrate in order to promote uniform deposition of the pretreatment composition (described below), as well as to promote the adhesion of the pretreatment composition coating to the substrate surface. Nonlimiting examples of suitable deoxidizers include a mechanical deoxidizer, which can be uniform roughening of the substrate surface, such as by using a scouring or cleaning pad, a chemical deoxidizer, nonlimiting examples of which include nitric acid, fluoroboric acid, sulfuric acid, chromic acid, hydrofluoric acid, and ammonium bifluoride, or Amchem 7/17 deoxidizers (available from Henkel Technologies, Madison Heights, Mich.), OAKITE DEOXIDIZER LNC (commercially available from Chemetall), TURCO DEOXIDIZER 6 (commercially available from Henkel), or combinations thereof. Often, the chemical deoxidizer includes a carrier, often an aqueous medium, so that the deoxidizer can be in the form of a solution or dispersion in the carrier, in which case the solution or dispersion can be brought into contact with the substrate by any of a variety of known techniques, such as dipping or immersion, spraying, intermittent spraying, dipping followed by spraying, spraying followed by dipping, brushing, or roll-coating.

In accordance with the methods of the present disclosure, the coating composition can be a pigmented coating composition such as a pigmented basecoat coating composition. The methods may further comprise applying a primer layer or a pigmented basecoat layer on the substrate prior to applying the pigmented basecoat coating composition to at least a portion of the substrate using a high transfer efficiency applicator. The methods may further comprise forming a clearcoat coating layer by applying a clearcoat coating composition over at least a portion of the basecoat layer using a high transfer efficiency applicator. For the avoidance of doubt, in the disclosed methods, any layer can be conventionally applied as long as at least one layer of the multiple coating layers is applied using a high transfer efficiency applicator.

The coating compositions of this disclosure can include pigments and/or dyes as colorants. As a nonlimiting example, the coating compositions in this disclosure can be pigmented basecoat coating composition. Non-limiting examples of suitable pigments include organic and/or inorganic materials, non-treated aluminum, treated aluminums (with silica, inorganic pigments and/or organic pigments), titanium dioxide, zinc oxide, iron oxide, carbon black, carbazole dioxazine crude pigment, azo, monoazo, disazo, naphthol AS, salt type (lakes), benzimidazolone, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalonc pigments, dikcto pyrrolo pyrrole red (“DPPBO red”), mono azo red, red iron oxide, quinacridone maroon, transparent red oxide, cobalt blue, iron blue, iron oxide yellow, chrome titanate, titanium yellow, nickel titanate yellow, reduced and/or composite tungsten oxide, transparent yellow oxide, lead chromate yellow, bismuth vanadium yellow, pre darkened chrome yellow, transparent red oxide chip, iron oxide red, molybdate orange, molybdate orange red, radar reflective pigments, LiDAR reflective pigments, corrosion inhibiting pigments, and combinations thereof.

Non-limiting examples of suitable dyes include those that are solvent and/or aqueous based such as photochromic dyes, acid dyes, azoic dyes, basic dyes, direct dyes, disperse dyes, reactive dyes, solvent dyes, sulfur dyes, mordant dyes, nonlimiting examples including bismuth vanadate, anthraquinone, perylene, aluminum, quinacridone, thiazole, thiazine, azo, indigoid, nitro, nitroso, oxazine, phthalocyanine, quinoline, stilbene, and triphenyl methane, dioxazine carbazole violet, phthalocyanine blue, indanthrone blue, mono azo permanent orange, ferrite yellow, diarylide yellow, indolinone yellow, monoazo yellow, benzimidazolone yellow, isoindoline yellow, tetrachloroisoindoline yellow, disazo yellow, anthanthrone orange, quinacridone orange, benzimidazolone orange, phthalocyanine green, quinacridone red, azoic red, diketopyrrolopyrrole red, perylene red, scarlet or maroon, quinacridone violet, thioindigo red, and combinations thereof.

When the coating compositions of this disclosure include a dye, as a nonlimiting example, the dye can include a photosensitive composition and/or photochromic composition, which reversibly alters its color when exposed to one or more light sources. The photosensitive composition and/or photochromic composition can be used in the coating compositions of this disclosure or in a number of layers in the multi-layer composites described herein. Photochromic and/or photosensitive compositions can be activated by exposure to radiation of a specified wavelength. As a nonlimiting example, when the photochromic and/or photosensitive composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. As a nonlimiting example, the photochromic and/or photosensitive composition can be colorless in a non-excited state and exhibit a color in an excited state. Full color-change may appear within milliseconds to several minutes, such as from 0.01 seconds to 120 seconds or 20 seconds to 60 seconds. A nonlimiting example of photochromic and/or photosensitive compositions include photochromic dyes.

As a nonlimiting example of the photosensitive composition and/or photochromic composition being used in the coating compositions of this disclosure, the photosensitive composition and/or photochromic composition can be associated with and/or at least partially bound to, such as by covalent bonding, a polymerizable ethylenically unsaturated monomer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with the present disclosure, have minimal migration out of the coating. Example photosensitive compositions and/or photochromic compositions and methods for making them are described in U.S. Pat. No. 8,153,344 col. 9, line 7 through col. 11, line 7 and col. 11, line 23 through col. 15, line 5, the specific portions thereof are incorporated herein by reference.

The coating composition can include a radar reflective pigment or a LiDAR reflective pigment or an infrared reflective pigment. The LiDAR, radar reflective pigment or infrared reflective pigment can include, but is not limited to, nickel manganese ferrite blacks (Pigment Black 30), iron chromite brown-blacks (CI Pigment Green 17, CI Pigment Browns 29 and 35), Pigment Blue 28, Pigment Blue 36, Pigment Green 26, Pigment Green 50, Pigment Brown 33, Pigment Brown 24, Pigment Black 12 and Pigment Yellow 53 and combinations thereof.

As a nonlimiting example, the LiDAR reflective pigment can include a semiconductor and/or a dielectric (“SCD”) in which a metal can be dispersed. The medium (e.g., SCD) in which the metal can be dispersed may also be referred to herein as the matrix. The metal and matrix can form a non-homogenous mixture that can be used to form the pigment. The metal can be dispersed uniformly or non-uniformly throughout the matrix. The semiconductor of the LiDAR reflective pigment can include, as nonlimiting examples, silicon, germanium, silicon carbide, boron nitride, aluminum nitride, gallium nitride, silicon nitride, gallium arsenide, indium phosphide, indium nitride, indium arsenide, indium antimonide, zinc oxide, zinc sulfide, zinc telluride, tin sulfide, bismuth sulfide, nickel oxide, boron phosphide, titanium dioxide, barium titanate, iron oxide, doped version thereof (i.e., an addition of a dopant, such as, for example, boron, aluminum, gallium, indium, phosphorous, arsenic, antimony, germanium, nitrogen, at a weight percentage of 0.01% or less based on the weight of the LiDAR reflective pigment), alloyed versions of thereof, other semiconductors, or combinations thereof. As a nonlimiting example, the LiDAR reflective pigment can comprise silicon. The dielectric of the LiDAR reflective pigment can comprise solid insulator materials (e.g., silicon dioxide), ceramics (e.g., aluminum oxide, yttrium oxide, yttria alumina garnet (YAG), neodymium-doped YAG (Nd:YAG)), glass (e.g., borosilicate glass, soda lime silicate glass, phosphate glass), organic materials, doped versions thereof, other dielectrics, or combinations thereof. The organic material can comprise, for example, acrylics, alkyds, chlorinated polyether, diallyl phthalate, epoxies, epoxy-polyamid, phenolics, polyamide, polyimides, polyesters (e.g., PET), polyethylene, polymethyl methacrylate, polystyrene, polyurethanes, polyvinyl butyral, polyvinyl chloride (PVC), copolymer of PVC and vinyl, acetate, polyvinyl formal, polyvinylidene fluoride, polyxylylenes, silicones, nylons and co-polymers of nylons, polyamide-polymide, polyalkene, polytetrafluoroethylene, other polymers, or combinations thereof. If the dielectric comprises organic materials, the organic materials are selected such that the pigment formed therefrom is resistant to melting and/or resistant to changes in dimension or physical properties upon incorporation into a coating, film, and/or article formulation. The metal in the LiDAR reflective pigment can comprise, for example, aluminum, silver, copper, indium, tin, nickel, titanium, gold, iron, alloys thereof, or combinations thereof. The metal can be in particulate form and can have an average particle size in a range of 0.5 nm to 100 nm, such as, for example, 1 nm to 10 nm as measured by a transmission electron microscope (TEM) at 100 kV. The metal can be in particulate form and can have an average particle size less than or equal to 20 nm as measured by TEM. Suitable methods of measuring particle sizes by TEM include suspending metal particles in a solvent, and then drop casting the suspension onto a TEM grid which is allowed to dry under ambient conditions. Particle size measurements may be obtained from images acquired using a Tecnai T20 TEM operating at 200 kV and analyzed using ImageJ software, or an equivalent instrument and software.

As a nonlimiting example, the coating composition can include corrosion inhibiting pigments. Any suitable corrosion inhibiting pigment known in the art can be utilized in the coating compositions, nonlimiting examples include Calcium Strontium Zinc Phosphosilicate; double orthophosphates, in which one of the cations is represented by zinc, nonlimiting examples being Zn—Al, Zn—Ca, Zn—K, Zn—Fc, Zn—Ca—Sr, Ba—Ca, Sr—Ca and combinations thereof; combinations of phosphate anion with anticorrosively efficient anions, nonlimiting examples being silicate, molybdate, and borate; modified phosphate pigments modified by organic corrosion inhibitors and combinations thereof. Nonlimiting examples of modified phosphate pigments include aluminum (III) zinc (II) phosphate, basic zinc phosphate, zinc phosphomolybdate, zinc calcium phosphomolybdate, zinc borophosphate, zinc strontium phosphosilicate, calcium barium phosphosilicate, calcium strontium zinc phosphosilicate, and combinations thereof. Other nonlimiting examples of corrosion inhibiting pigments that can be used in the coating formulation include zinc 5-nitroisophthalate, calcium 5-nitroisophthalate, calcium cyanurate, metal salts of dinonylnaphthalene sulfonic acids, and combinations thereof.

When colorants are included in the coating compositions, the colorants can be included at a level of at least 0.1 wt. %, such as at least 0.15 wt. %, at least 0.2 wt. %, at least 0.5 wt. % and at least 1 wt. % and can be included at up to 40 wt. %, such as up to 37 wt. %, and up to 34 wt. % based on the weight of the coating composition. Further the amount of colorant can be from 0.5 to 40 wt. %, such as from 0.15 to 38 wt. % and from 1 to 34 based on weight of the coating composition. When the amount of colorant is too low, the desired color effect from the coating may not be achieved. When the amount of colorant is too high, the rheological profile of the coating composition may be adversely affected. When colorants are included in the coating compositions, the colorants can be included at any level or range between (and include) any of the levels indicated above.

As a nonlimiting example, the coating compositions can include various other components, such as binders, carriers, water, catalysts, conventional additives, or combinations thereof. Conventional additives can include, but are not limited to, dispersants, antioxidants, and absorbers, wetting agents, leveling agents, antifoaming agents, anti-cratering agents, thermoplastic resins, plasticizers, abrasion resistant particles, fillers including, but not limited to, micas, talc, clays, and inorganic minerals, metal oxides, metal flake, various forms of carbon, anti-oxidants, hindered amine light stabilizers, UV light absorbers and stabilizers, surfactants, flow and surface control agents, thixotropic agents, reactive diluents, catalysts, reaction inhibitors, corrosion-inhibitors, other customary auxiliaries and combinations thereof. The coating composition can be suitable for application to a substrate.

As a nonlimiting example, when a metal flake pigment is used, it can have an aspect ratio of from 5:1 to 500:1, such as from 10:1 to 200:1.

The coating compositions of this disclosure can be applied by any means, such as spraying, electrostatic spraying, dipping, rolling brushing, immersion, spraying, intermittent spraying, dipping followed by spraying, spraying followed by dipping, brushing, roll-coating and the like. The coating composition can also be applied with precision application devices that can apply the coating composition without any overspray. Such devices can therefore apply the coating compositions over a substrate that is not masked with a removable material (such as taping materials for example). The properties of the coating compositions described herein used in combination with the precision application devices can enable the coating composition to be applied over at least a portion of the substrate without overspray.

The methods according to this disclosure include applying the coating compositions described herein using a high transfer efficiency applicator. As a nonlimiting examples, a clearcoat coating composition can be applied over at least a portion of the coating composition that has been applied to the substrate. Either or both of the coating compositions can be applied using a high transfer efficiency applicator.

The application devices that apply coating compositions without overspray can be used to produce a desired pattern and/or design over the substrate. As a nonlimiting example, these application devices can apply coating compositions in a single pass without masking the substrate to produce two or more colors over different portions of the substrate.

Non-limiting examples of devices that can apply coating compositions without overspray include devices that apply compositions as a continuous jet, as continuous droplets, and/or as a drop on-demand. Specific non-limiting examples of such devices include Piezo actuated valvejets, air actuated valvejets, continuous inkjet printers, gas-ejection droplet generators, vibrating tip droplet generators, piezo-actuated micropneumatic droplet generators, and electrohydrodynamic droplet generators.

The applicator can be a high transfer efficiency applicator that includes a nozzle that includes an opening. The high transfer efficiency applicator can include more than one, or a plurality of nozzles. The nozzle opening can have any suitable shape, nonlimiting examples being circular, elliptical, square and rectangular. The nozzle can include a channel that has the same cross-sectional shape and dimensions of the opening. The nozzle opening can have a diameter of from at least 20 μm, such as at least 25 μm, at least 50 μm and at least 75 μm and can be up to 400 μm, such as up to 300 μm up to 275 μm, up to 250 μm, up to 225 μm and up to 200 μm and can be from 20 μm to 400 μm, such as 25 μm to 300 μm, 25 μm to 250 μm, 25 μm to 200 μm, 50 μm to 300 μm, 50 μm to 250 μm, 50 μm to 200 μm, 75 μm to 300 μm, 75 μm to 250 μm, and 75 μm to 200 μm. The nozzle opening can be any value or range between (and include) any value recited above. Droplets or a stream emitted from the nozzle can have the same diameter as the nozzle opening.

As a nonlimiting example, the high transfer efficiency applicator can include one or more nozzles having a nozzle orifice with a diameter ranging from 20 to 400 μm, such as from 25 to 350 μm or 35 to 300 μm and, further wherein the droplets or jets expelled from the orifice each have a diameter of from 20 to 400 μm, such as from 25 to 350 μm or 35 to 300 μm.

The droplet diameter can be determined using a JetXpert drop watcher and its analyze now function in double pulse mode, available from ImageXpert, Inc. Similarly, the nozzle diameter can be determined using the Nozzle Examiner feature of JetXpert.

The coating composition can be provided to the applicator under pressure (for example, greater than 1 atmosphere). In many cases, the plurality of nozzles each include a cylindrical channel having the same diameter as the nozzle opening. The combination of the pressure and channel dimensions results in a shear stress being applied to the coating composition. The shear thinning property of the coating composition as described above allows the coating composition to be expelled from the nozzles at a desired stream flow rate or droplet rate.

The stream flow rate or droplet rate can be from at least 25 cc/min., such as at least 50 cc/min, and at least 75 cc/min, and can be up to 300 cc/min., such as up to 275 cc/min., up to 250 cc/min., up to 225 cc/min, and up to 200 cc/min, and can be from 25 cc/min. to 300 cc/min., such as 50 cc/min. to 300 cc/min., 75 cc/min. to 300 cc/min., 25 cc/min. to 250 cc/min., 50 cc/min. to 250 cc/min., 75 cc/min. to 250 cc/min., 25 cc/min. to 200 cc/min., 50 cc/min. to 200 cc/min. and 75 cc/min. to 200 cc/min. When the flow rate or droplet rate is too low, the coating layer may not have desired properties. If the flow rate or droplet rate is too high, the coating can be prone to puddling and/or sag. The flow rate or droplet rate can be any value or range between (and include) any value recited above.

The coating compositions described herein, when applied according to the methods and systems described herein have a high transfer efficiency, in other words, most, if not all, of the coating composition is applied to the substrate after leaving an applicator and is not wasted and/or over sprayed. The transfer efficiency of the coating composition can be at least 90 wt. %, such as at least 91 wt. %, at least 92 wt. % and at least 93 wt. % and can be up to 100 wt. %, such as up to 99 wt. % and up to 98 wt. % and can be from 90% to 100%, such as from 92% to 100% and 93 to 99%. The transfer efficiency of the coating composition can be any value or range between (and include) any of the values recited above.

The transfer efficiency can be aided by positioning the applicator in close proximity to the substrate. Thus, the distance from the tip of a nozzle in an applicator to the substrate can be from at least 0.5 cm, such as at least 0.6 cm and at least 0.75 cm and can be up to 5 cm, up to 4 cm and up to 3 cm and can be from 0.5 cm to 5 cm, such as 0.5 cm to 4 cm, 0.5 to 3 cm, 0.75 cm to 5 cm, 0.75 cm to 4 cm and 0.75 to 3 cm. The distance from the applicator to the substrate can be any value or range between (and include) any of the values recited above.

The high transfer efficiency of the coating composition and the close proximity of the applicator to the substrate can minimize any evaporation of volatile components from the coating composition while being applied to a substrate. The total solids of the applied coating composition can be within at least 10 wt. %, such as at least 7.5 wt. % and at least 5 wt. % and can be within 1 wt. %, such as within 2 wt. % and within 3 wt. % of the total solids of the coating composition entering the applicator. Often, there is no loss of volatile components and the composition of the applied coating composition is the same as the coating composition entering the applicator. The total solids of the applied coating composition compared to the total solids of the coating composition entering the applicator can be any value or range between (and include) any of the values recited above.

As described above, applicators suitable for use with the methods and systems described herein and useful with the coating composition can include a plurality of nozzles. The number of nozzles on an applicator can be at least one, such as at least 5 and at least 10 and can be up to 3,000, such as up to 2,700, up to 2,250, up to 2,000, up to 1,500, up to 1,000, up to 500, up to 100, up to 75, up to 70 and up to 65 and can be from 5 to 1,000, such as 10 to 500 and 10 to 100. The number of nozzles included in an applicator can be any value or range between (and include) any of the values recited above.

Depending on the number of nozzles included on an applicator, the applicator can have a path width of from at least 0.5 cm, such as at least 1 cm, at least 2.5 cm and at least 5 cm and can be up to 15 cm, such as up to 14 cm, up to 13 cm and up to 12 cm and can be from 1 cm to 15 cm, such as 2.5 cm to 14 cm and 5 to 15 cm. The path width of the coating composition can be any value or range between (and include) any of the values recited above.

Due to the high transfer efficiency, rheological profile of the coating composition, and use of the high efficiency applicators as described herein, there is minimal or no overlap between passes of an applicator within a target area or target deposition path.

Due to the high transfer efficiency, rheological profile of the coating composition, and use of the high efficiency applicators described herein, the applicator is able to traverse the substrate over a target area or target deposition path relatively quickly. Thus, the applicator can have a tip speed of from at least 50 mm/sec., such as at least 100 mm/sec, and at least 200 mm/sec, and can be up to 1000 mm/sec., such as up to 750 mm/see and up to 500 mm/see and can be from 50 mm/sec. to 1000 mm/sec., such as 50 mm/sec. to 750 mm/sec., 50 mm/sec. to 500 mm/sec., 100 mm/sec. to 1000 mm/sec., 100 mm/sec. to 750 mm/sec., 100 mm/sec. to 500 mm/sec., 200 mm/sec. to 1000 mm/sec., 200 mm/sec. to 750 mm/sec, and 200 mm/sec. to 500 mm/sec. The tip speed of the applicator can be any value or range between (and include) any of the values recited above.

The coating composition can be applied directly to a substrate and provide a primer coat. Additionally, the coating composition can be applied as a basecoat, and the basecoats can include colorants. Further, the coating composition can be a clearcoat that can cover at least a portion of any of the coatings described herein. The coating compositions described herein can be a final coat, or topcoat, that covers at least a portion of the coatings described herein.

The disclosure will be further described by reference to the following non-limiting examples.

### EXAMPLES

### Example 1 (High Acid Shell)

An acrylic latex was prepared as follows: a mixture of 1268 g of deionized water and 4.4 g of an alcohol ethoxylate surfactant (Rhodapex AB/20 available from Solvay Société anonymc) was charged to a four necked flask and heated to 65 °C with a nitrogen blanket.

A mixture of 6.4 g butyl acrylate, 19 g methyl methacrylate and 0.6 g methacrylic acid was added to the flask and heated to 85 °C. A solution of 0.21 g ammonium persulfate in 33 g deionized water was added and the resulting mixture held at 85 °C for 30 minutes.

A pre-emulsion of 753 g deionized water, 9.7 g Rhodapex AB/20, 473 g methyl methacrylate, 190 g butyl acrylate, 41.4 g 50% acrylamide solution, 17.5 g ethylene glycol dimethacrylate and 17.4 g hydroxy methyl methacrylate as added to the flask over 3 hours simultaneously with a solution of 0.58 g ammonium persulfate and 151 g deionized water. The resulting mixture was held for one hour at 85 °C.

A pre-emulsion of 95 g deionized water, 1.4 g Rhodapex AB/20, 39.5 g butyl acrylate, 49.3 g methacrylic acid, 18.1 g methyl methacrylate and 26.2 g hydroxy ethyl acrylate was added to the flask over 1.5 hours simultaneously with a solution of 0.3 g ammonium persulfate, 0.95 g granular borax and 116 g deionized water and held at 85 °C thereafter for two hours.

The resulting mixture was cooled to 70 °C and a solution of 6.3 g dimethyl ethanol amine in 39 g deionized water was added to the flask over 20 minutes. A biocide, Acticide (MBS), available from THOR AMERICAS, Inc., 8.9 g was dissolved in 31 g deionized water was added to the flask followed by 15.9 g deionized water. The resulting latex was then cooled to 23 °C.

The viscosity of the resulting latex was determined using a Brookfield viscometer available from AMETEK, Inc., using spindle #2 at 20 rpm and 23 °C as 1764 cps and particle size determined as 153.2 nm (Z average determined using a Zetasizer dynamic light scattering instrument available from Malvern Panalytical Ltd. The final total solids was determined to be 25.4 wt. % after placing a sample in a 110 °C for one hour and dividing the final weight by the weight of the initial sample. Particle size was measured by dynamic light scattering with a Malvern Zetasizer, a high performance two angle particle size analyzer for the enhanced detection of aggregates and measurement of small or dilute samples, and samples at very low or high concentration using dynamic light scattering.

### Example 2 (Comparative)

An acrylic latex was prepared as follows: a mixture of 1268 g of deionized water and 4.4 g of an alcohol ethoxylate surfactant (Rhodapex AB/20 available from Solvay Société anonyme) was charged to a four necked flask and heated to 65 °C with a nitrogen blanket.

A mixture of 6.4 g butyl acrylate, 19 g methyl methacrylate and 0.6 g methacrylic acid was added to the flask and heated to 85 °C. A solution of 0.21 g ammonium persulfate in 33 g deionized water was added and the resulting mixture held at 85 °C for 30 minutes.

A pre-emulsion of 753 g deionized water, 9.7 g Rhodapex AB/20, 473 g methyl methacrylate, 190 g butyl acrylate, 41.4 g 50% acrylamide solution, 17.5 g ethylene glycol dimethacrylate and 17.4 g hydroxy methyl methacrylate as added to the flask over 3 hours simultaneously with a solution of 0.58 g ammonium persulfate and 151 g deionized water. The resulting mixture was held for one hour at 85 °C.

A pre-emulsion of 95 g deionized water, 1.4 g Rhodapex AB/20, 39.5 g butyl acrylate, 24.7 g methacrylic acid, 18.1 g methyl methacrylate and 26.2 g hydroxy ethyl acrylate was added to the flask over 1.5 hours simultaneously with a solution of 0.3 g ammonium persulfate, 0.95 g granular borax and 116 g deionized water and held at 85 °C thereafter for two hours.

The resulting mixture was cooled to 70 °C and a solution of 6.3 g dimethyl ethanol amine in 39 g deionized water was added to the flask over 20 minutes. A biocide, Acticide (MBS), available from THOR AMERICAS, Inc., 8.9 g was dissolved in 31 g deionized water was added to the flask followed by 15.9 g deionized water. The resulting latex was then cooled to 23 °C.

The viscosity of the resulting latex was determined using a Brookfield viscometer available from AMETEK, Inc., using spindle #2 at 100 rpm and 23 °C as 43.6 cps and particle size determined as 151.9 nm (Z average determined using a Zetasizer dynamic light scattering instrument available from Malvern Panalytical Ltd. The final total solids was determined to be 24.7 wt. % after placing a sample in a 100 °C for one hour and dividing the final weight by the weight of the initial sample.

### Examples 3-10

Waterborne thermoset basecoats were prepared by weighing the amounts inTable 1 into a vessel with agitation. Water was added to the designed amount and dimethyl ethanolamine (DMEA, aqueous 50 wt. % solution) was slowly added with agitation while measuring the pH of the mixture until a range of 8.5 to 8.7 was reached. The remaining ingredients of the formula were added with agitation so as not to create foam. Samples were retested for 24 hours and readjusted with DMEA with agitation until the pH of the mixture maintained a range of 8.5 to 8.7.

Samples were measured for shear flow viscosity using an Anton Paar, MCR301 Rheometer using a bob concentric cylinder apparatus (CC27 with gap size of 1.13 mm), where the viscosity was measured in centipoise (cps) over a range of 0.1 sec-1 to 1000 sec-1. Samples were applied through a EcoPaintJet precision applicator, nozzle plate: M09150011 (Dürr Systems AG), onto electrocoat primed steel panels to a target film thickness for appearance and sag evaluation (Examples 3-10). Examples 5 through 9 were also evaluated at a lower film thickness. The panels were flashed at ambient conditions of 25 °C for 4 minutes prior to a 7-minute heated flash at 70 °C and final bake for 20 minutes at 140 °C.

TABLE 1

| | | | | | | | | Example |
|---|---|---|---|---|---|---|---|---|
| | | | | | | | | 10 |
| | Example | Example | Example | Example | Example | Example | Example | (Compar- |
| | 3 | 4 | 5 | 6 | 7 | 8 | 9 | ative) |
| Example 1 | 28.4 | 22.8 | | 18.4 | 8.0 | 16.8 | 26.1 | |
| (wt. %) | | | | | | | | |
| Example 2 | | | 27.5 | | | | | 28.4 |
| (wt. %) | | | | | | | | |
| Dispersion¹ | | | | | 14.9 | 6.3 | | |
| (wt. %) | | | | | | | | |
| Deionized | 24.6 | 19.7 | | | | | | 24.6 |
| water | | | | | | | | |
| DMEA | 0.7 | 0.6 | 0.9 | 0.4 | 0.5 | 0.6 | 0.6 | 0.7 |
| (50 wt. %) | | | | | | | | |
| Waterborne | 11.5 | 9.2 | 9.0 | 6.5 | 10.3 | 9.1 | 9.3 | 11.5 |
| black tint² | | | | | | | | |
| Melamine resin³ | 4.9 | 3.9 | 3.8 | 2.1 | 3.4 | 3.0 | 3.1 | 4.9 |
| 2-ethylhexanol | 1.6 | 1.3 | 1.2 | 2.7 | 4.3 | 1.3 | 3.8 | 1.6 |
| 2-butoxyethanol | 0.4 | 0.4 | 0.3 | 0.8 | 1.2 | 0.4 | 1.1 | 0.4 |
| Odorless | 0.4 | 0.3 | 0.3 | 0.6 | 1.0 | 0.3 | 0.9 | 0.4 |
| mineral spirits | | | | | | | | |
| EVA Wax⁴ | | 2.4 | 5.2 | 2.1 | 3.4 | 3.0 | | |
| Deionized | 27.5 | 39.3 | 51.7 | 66.4 | 53.0 | 59.5 | 55.1 | 27.5 |
| Water | | | | | | | | |
| Total Solids | 14.3 | 12.0 | 13.6 | 8.5 | 13.6 | 12.0 | 11.5 | 14.3 |
| (wt. %) | | | | | | | | |
| Total solids | 12.2 | 10.2 | 11.6 | 7.2 | 11.7 | 10.3 | 9.7 | 12.2 |
| (vol. %) | | | | | | | | |
| VOC (less | 260 | 250 | 230 | 390 | 380 | 240 | 400 | 260 |
| water) (g/L) | | | | | | | | |
| Viscosity | 6532 | 19339 | 30074 | 24350 | 6850 | 10804 | 5761 | 16 |
| @0.1(s⁻¹) (cps) | | | | | | | | |
| Visc. | 50 | 71 | 95 | 71 | 72 | 70 | 71 | 13 |
| @1000(s⁻¹) | | | | | | | | |
| (cps) | | | | | | | | |
| DFT (μm) | 19 | 21 | 19 | 19 | 19 | 18 | 17 | 18 |
| Horiz. | 4 | 4 | 4 | 4 | 4 | 4 | 4 | 3 |
| Appearance | | | | | | | | |
| DFT (μm) | n/a | n/a | 13 | 13 | 13 | 13 | 12 | n/a |
| Horiz. | n/A | n/a | 4 | 4 | 4 | 4 | 4 | n/a |
| Appearance | | | | | | | | |
| Vertical | >19 | >21 | >19 | >19 | >16 | >16 | >17 | <9 |
| Sag limit | | | | | | | | |

¹Urethane-acryl-hybrid dispersion, Daotan vtw 6463/36WA available from Allnex GMBH
²similar to Envirobase T409 Black WB Tint available from PPG
³Resimene HM-2608 available from INEOS Melamines GmbH
⁴Ethyle-vnyl acetate copolymer wax, Aquatix 8421 available from BYK-Chemie GmbH

### Horizontal Appearance Rating Scale

0—severe dewetting between nozzles, 100% of area affected
1—moderate/severe dewetting, 50-75% of total area affected
2—moderate dewetting, 25-50% of total area affected
3—slight dewetting, 1-25% of total area affected
4—no dewetting, no visible difference between nozzles, completely consistent coating

Example 3 and Example 10 were identical in composition, apart from Example 3 containing the high acid core-shell resin (Example 1) and Example 10 containing the low acid core-shell resin (Example 2). Example 3 demonstrated non-Newotnian flow behavior, having a much higher viscosity at low shear (0.1 s⁻¹) than the viscosity at high shear (1000 s⁻¹), while Example 10 demonstrates Newtonian flow behavior, having a similar viscosity at high shear (1000 s⁻¹) and low shear (0.1 s⁻¹). The rheology of Example 3 allowed the coating to provide improved appearance and resistance to vertical sag when compared to Example 10.

Example 4 explored reducing the total solids of the coating by using a small amount of rheology modifier (Aquatix 8421) and Example 6 explored reducing the total solids of the coating by using both a small amount of rheology modifier (Aquatix 8421) and the addition of more organic solvent. Both Example 4 and Example 6 had a desired rheology profile and provided good application performance, in particular improved appearance and vertical sag compared to Example 10.

Example 5 explored the use of the low acid core-shell resin (Example 2) with higher amounts of rheology modifier (Aquatix 8421) to achieve a desired low shear viscosity. Application performance wa improved compared to Example 10.

Examples 7 and 8 explored lower amounts of high acid core-shell resin, replacing the Example 1 resin with a commercially available core-shell resin to make up the difference in total solids. The coating compositions of Examples 7 and 8 provided good application performance in particular improved appearance and vertical sag when compared to Example 10.

Example 9, in many respects, was a lower solids version of Example 3 and provided good application performance in particular improved appearance and vertical sag when compared to Example 10.

### Examples 11-16

The core-shell resins of Examples 1 and 2 were evaluated at various concentrations, at pH of 8.5-8.7, on an Anton-Paar MCR301 rheometer equipped with a 50-millimeter cone and plate fixture at 25 °C and a pressure of 101.3 kPa (1 atm) to determine the minimum nonvolatile content required for the solution to behave as a gel (G′>G″). The G′ and G″ values were measured at ω=1 rad/s and γ=1% at each concentration. The gel transition was determined to be the wt. % NV when G′ became greater than G″, or, in other words, when the loss modulus, tan (δ) (tan (δ)=G″/G′) becomes less than 1. The results are shown in TABLE 2.

TABLE 2

| | Core-Shell | Resin | | | | |
|---|---|---|---|---|---|---|
| Example | Resin | (wt. %) | G′ (Pa) | G″ (Pa) | Tan (δ) | |
| 11 | Example 1 | 14 | 125.940 | 24.521 | 0.195 | Gel |
| 12 | Example 1 | 12 | 52.642 | 10.795 | 0.205 | Gel |
| 13 | Example 1 | 10 | 0.003 | 0.131 | 38.309 | Liquid |
| 14 | Example 2 | 22 | 58.291 | 12.099 | 0.208 | Gel |
| 15 | Example 2 | 20 | 25.507 | 7.793 | 0.306 | Gel |
| 16 | Example 2 | 18 | 0.360 | 1.620 | 4.499 | Liquid |

The data show that the core-shell resin of Example 1 had a gel transition that occurs at less than 12 wt. % NV, while the core-shell resin of Example 2 had a gel transition that occurs at greater than 18 wt. % NV (greater than 15 wt. % NV).

Whereas particular embodiments of this disclosure have been described above for purposes of illustration, it will be evident to those skilled in the art that numerous variations of the details of the present disclosure can be made without departing from what is defined in the appended claims.

1. A coating composition comprising
6 to 15 wt. % total solids, based on the weight of the coating composition;
15 to 70 wt. % based on the total solids, of core-shell resin particles; and
50 to 550 g/L volatile organic compound (VOC) content;
wherein the coating composition has a viscosity at 1000 s⁻¹ of from 30 to 110 mPa·s and a viscosity at 0.1 s⁻¹ of greater than 1000 mPa·s measured using an Anton-Paar MCR301 rheometer equipped with a concentric cylinder fixture (CC27 with gap size of 1.13 mm) at 25 °C and a pressure of 101.3 kPa (1 atm);
wherein total solids and VOC are determined according to ASTM D2369 (2020) and ASTM D3960-05 respectively; and
wherein the coating composition is capable of being applied using a high transfer efficiency precision applicator.

2. The coating composition according to claim 1, wherein the core-shell resin particles comprise a viscoelastic gel that when dispersed in an aqueous medium at from greater than 0 wt. % to less than 14 wt. % at a pH of 8.5 to 8.7 has a G′ value greater than a G″ value measured at ω=1 rad/s and γ=1% using an Anton-Paar MCR301 rheometer equipped with a 50-millimeter cone and plate fixture at 25 °C and a pressure of 101.3 kPa (1 atm).

3. The coating composition according to claim 1, wherein the core-shell resin particles comprise
a core derived from polymerizing a monomer mixture that includes
0 to 99 wt. % of first nonionic monomers conforming to the formula:
R¹₂C═CR¹—C(O)—W—R⁶
wherein each R¹ is independently —H, —CH₃ or —CH₂CH₃;
W is selected from O, NR⁴, and S;
R⁴ is H, CH₃ or CH₂CH₃; and
R⁶ is selected from C₁ to C₁₂ alkyl, C₅ to C₁₂ cycloaliphatic, and C₆ to C₁₂ aromatic or alkyl aromatic and can optionally include-OH substitution for one or more hydrogens;
0 to 4 wt. % carboxylic monomers conforming to the formula:
R²₂C═CR²—C(O)—OH
wherein each R² is independently —H, —CH₃ or —CH₂CH₃; and
0 to 100 wt. % vinyl monomers conforming to the formula:
R¹₂C═CR¹-A-C(O)—R⁹
wherein each R¹ is independently —H, —CH₃ or —CH₂CH₃;
A is NR⁴ or O;
R⁴ is H, CH₃ or CH₂CH₃; and
R⁹ is a linear or branched alkyl group having 1 to 18 carbon atoms, or R⁹ is bonded to A to form a 5- to 7-member ring when A is nitrogen;
a shell derived from polymerizing a monomer mixture comprising
0 to 40 wt. % second nonionic monomers conforming to the formula:
R¹₂C═CR¹—C(O)—Z—R⁷
wherein each R¹ is independently —H, —CH₃ or —CH₂CH₃;
Z is selected from O, NR⁴, S and a group according to the formula
—(O—CR⁸—CR⁸—)ₙ—O—
wherein each R⁸ is independently —H, —CH₃ or —CH₂CH₃; and n is 0 to 30, such as 0 to 25 or 1 to 25;
R⁷ is selected from C₁ to C₁₈ alkyl, C₅ to C₁₂ cycloaliphatic, and C₆ to C₁₈ aromatic or alkyl aromatic and can optionally include-OH substitution for one or more hydrogens;
R⁴ is H, CH₃ or CH₂CH₃; and
2 to 50 wt. % carboxylic monomers conforming to the formula:
R²₂C═CR²—C(O)—OH
wherein each R² is independently —H, —CH₃ or —CH₂CH₃; and
0 to 50 wt. % vinyl monomers conforming to the formula:
R¹₂C═CR¹-A-C(O)—R⁹
wherein each R¹ is independently —H, —CH₃ or —CH₂CH₃;
A is NR⁴ or O;
R⁴ is H, CH₃ or CH₂CH₃; and
R⁹ is a linear or branched alkyl group having 1 to 18 carbon atoms, or R⁹ is bonded to A to form a 5- to 7-member ring when A is nitrogen.

4. The coating composition according to claim 3, wherein after monomers conforming to the formula:
R¹₂C═CR¹-A-C(O)—R⁹
are incorporated into either or both of the core or shell of the core-shell resin particles, the incorporated residues are hydrolyzed to leave a hydroxyl group (if A is oxygen) or amine group (if A is nitrogen).

5. The coating composition according to claim 1 comprising an aqueous carrier comprising 60 to 93 wt. % water.

6. (canceled)

7. The coating composition according to claim 1 having a pH of from 7.5 to 10.

8. (canceled)

9. The coating composition according to claim 1 comprising a rheology modifier selected from inorganic thixotropic agents, an acrylic alkali swellable emulsion (ASE), a hydrophobically modified ethylene oxide urethane block copolymer (HEUR), hydrophobically-modified, alkali swellable emulsion (HASE) and hydrophobically-modified hydroxy ethyl cellulose (HMHEC), copolymer of ethylene and vinyl acetate (EVA wax), and mixtures thereof.

10. The coating composition according to claim 1, wherein the amount of the rheology modifier in the coating composition is from 0 to 10 wt. % based on the total solids of the coating composition.

11. The coating composition according to claim 1 comprising a film-forming polymer or resin comprising at least one crosslinking-functional group and a crosslinking material comprising at least one functional group reactive with the crosslinking-functional group.

12. The coating composition according to claim 11, comprising the crosslinking material at from 1 to 30 wt. % based on the total solids of the coating composition.

13. The coating composition according to claim 11, wherein the film-forming polymer or resin comprises a crosslinking-functional group selected from hydroxyl groups, carboxyl groups, amine groups and aminoplast groups.

14. (canceled)

15. A method of forming a coating layer on at least a portion of a substrate comprising:
applying a coating composition to a substrate using a high transfer efficiency applicator;
wherein the coating composition comprises a coating composition according to claim 1.

16. (canceled)

17. The method according to claim 15, wherein the high transfer efficiency applicator comprises multiple nozzles and each nozzle expels the coating composition to form a jet having the form of a line segment, a planar jet or lamina, a hollow cylindrical jet, or wherein the nozzles cooperatively expel the coating composition to form a liquid sheet.

18. The method according to claim 15, wherein the coating composition is a pigmented basecoat coating composition.

19. The method according to claim 15, wherein the method comprises applying a primer layer on the substrate prior to applying the coating composition and/or
wherein multiple coating layers are applied to the substrate prior to applying the coating composition;
wherein the multiple coating layers are selected from primer layer, basecoat, topcoat and clearcoat.

20. (canceled)

21. (canceled)

22. The method according to claim 15, comprising applying, using a high transfer efficiency applicator, a clearcoat coating composition over at least a portion of the coating composition that has been applied to the substrate.

23. The method according to claim 15, wherein the nozzle orifice has a diameter ranging from 20 to 400 μm and, further wherein the droplets or jets expelled from the orifice each have a diameter of from 20 to 400 μm.

24. A substrate coated by the method as claimed in claim 15.

25. The substrate as claimed in claim 24, wherein the substrate is a vehicle or a portion thereof.

26. The coating composition according to claim 1 comprising a photosensitive composition and/or a photochromic composition.
